(19) United States
(12) Patent Application Publication
(10) Pub. No.: US 2020/0383177 A1
(43) Pub. Date: Dec. 3, 2020

(54) SENSOR FREE HEATED HOSE

(71) Applicant: Graco Minnesota Inc., Minneapolis, MN (US)

(72) Inventors: Nicholas P. Peterson, Coon Rapids, MN (US); Mark J. Brudevold, St. Cloud, MN (US); Benjamin R. Godding, St. Cloud, MN (US); Joseph E. Tix, Hastings, MN (US); Mark T. Weinberger, Mounds View, MN (US)

(21) Appl. No.: 16/887,369

(22) Filed: May 29, 2020

Related U.S. Application Data
(60) Provisional application No. 62/855,501, filed on May 31, 2019.

(51) Int. Cl. H05B 3/58; B05B 9/00; H05B 1/02; H05B 3/12; H05B 3/00

(52) U.S. Cl. CPC H05B 3/58; B05B 9/002; H05B 2203/035; H05B 3/12; H05B 3/0019; H05B 1/0244

(57) ABSTRACT

A method of regulating a temperature of a fluid within a hose of a fluid dispensing system includes passing the fluid through the hose and across a heating element. A temperature of the fluid in the hose is sensed by the heating element. The sensed temperature of the fluid in the hose is compared to a reference temperature. An input of the heating element is adjusted in response to the comparison of the sensed temperature of the fluid in the hose to the reference temperature such that the temperature of the fluid is adjusted towards the reference temperature.

### CROSS-REFERENCE TO RELATED APPLICATION(S)

This application claims the benefit of U.S. Provisional Application No. 62/855,501 filed May 31, 2019 for “SENSOR FREE HEATED HOSE” by N. Peterson, M. Brudevold, B. Godding, J. Tix, and M. Weinberger.

### BACKGROUND

The present disclosure relates generally to heated fluid delivery systems and more particularly to heated hoses.

With fluid delivery system applications requiring delivery of a fluid through a hose exposed to ambient temperatures, ambient temperatures can adversely reduce a temperature of the fluid in the hose, rendering the fluid ineffective for the particular application. For instance, the application of spray foam insulation can involve pumping reactive fluids through one or more hoses exposed to varying ambient temperatures. In some low temperature environments, the physical properties of the fluids can be changed during the application process, causing the application to fail or resulting in the application of an ineffective product.

In existing heated fluid delivery systems, fluid temperature sensors are susceptible to physical damage during use and provide a potential failure point within the fluid dispensing system.

### SUMMARY

A method of regulating a temperature of a fluid within a hose of a fluid dispensing system includes passing the fluid through the hose and across a heating element. A temperature of the fluid in the hose is sensed by the heating element. The sensed temperature of the fluid in the hose is compared to a reference temperature. An input of the heating element is adjusted in response to the comparison of the sensed temperature of the fluid in the hose to the reference temperature such that the temperature of the fluid is adjusted towards the reference temperature.

A heated hose assembly for managing a fluid includes a hose, a heating element mounted to the hose, and a control unit detachably affixed to and in fluid communication with the hose. The hose includes a protective cover, a core disposed radially inward from the protective cover, and a channel formed by an internal cavity of the hose. The channel extends through the hose and is configured to transport the fluid through the hose. The heating element extends along a length of the hose and is configured such that the resistance of the heating element changes in response to a change in a temperature of the heating element. The control unit is configured to supply a pressurized source of fluid into the channel of the hose, to supply current to the heating element, and to sense the resistance of the heating element.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a perspective view of a system for dispensing a fluid with a hose.

FIG. 2 is a cross-section view of the hose taken at 2-2 shown in FIG. 1.

FIG. 3 is a flowchart of a method of regulating a temperature of a fluid within the hose.

While the above-identified figures set forth one or more embodiments of the present disclosure, other embodiments are also contemplated, as noted in the discussion. In all cases, this disclosure presents embodiments by way of representation and not limitation. It should be understood that numerous other modifications and embodiments can be devised by those skilled in the art, which fall within the scope and spirit of the principles of the disclosure. The figures may not be drawn to scale, and applications and embodiments of the present disclosure may include features and components not specifically shown in the drawings.

### DETAILED DESCRIPTION

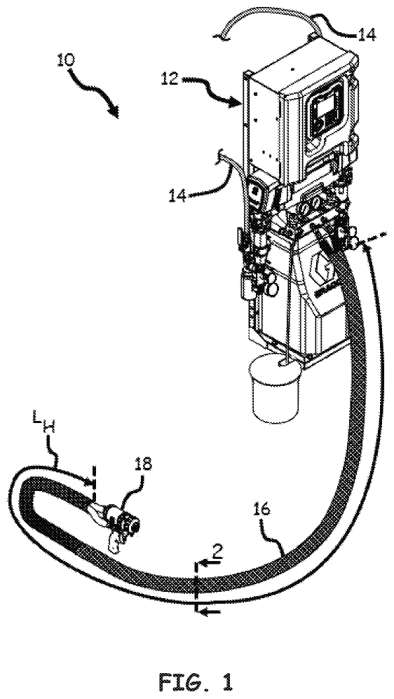

FIG. 1 is a perspective view of system 10 for dispensing a fluid and shows control unit 12, supply lines 14, hose 16 (with length L_{H}), and spray gun 18.

System 10 is a fluid management system. In this example, system 10 is a system for spraying polyurethane foam and polyurea coatings. Control unit 12 is a module for controlling a flow of fluid through system 10. In this example, control unit 12 is a plural component proportioner. In one non-limiting embodiment, control unit 12 can include a power supply, a temperature sensor, a resistance sensor, an amp meter, a fluid compressor, a motor, and/or fluid supply tanks. Supply lines 14 and hose 16 are fluid hoses in the form of elongated tubes. In this example, hose 16 is a heated hose. Length L_{H} is a length of hose 16. Spray gun 18 is an attachment configured to control an output of fluid from hose 16.

Supply lines 14 are attached and fluidly connected to control unit 12. In one non-limiting embodiment, supply lines 14 can be connected to a feed pump of a fluid supply tank and/or a fluid refuse tank. Hose 16 is also attached and fluidly connected to control unit 12. Length L_{H} spans the entire length of hose 16. Spray gun 18 is mounted to a terminal end of hose 16 on an opposite end of hose 16 from control unit 12. In this example, spray gun 18 can be removably fastened to hose 16 (e.g. by a threaded connection) to allow spray gun 18 to be interchanged with alternate spray nozzles to accommodate different spray specifications.

System 10 is used for the application of a spray foam insulation, which can involve pumping reactive fluids through one or more hoses. In one non-limiting embodiment, system 10 is configured to for managing and applying polyurethane foam and polyurea coatings. In this example, system 10 can be used to automatically apply heat to a fluid flowing through hose 16 to maintain a desired fluid temperature during operation. System 10 can be used to automatically maintain the desired fluid temperature without operator input or control. Although system 10 can be suited for use in spray foam applications, it will be understood by one of ordinary skill in the art that system 10 can be utilized for a wide variety of applications that require the application of heat to a flowing fluid.

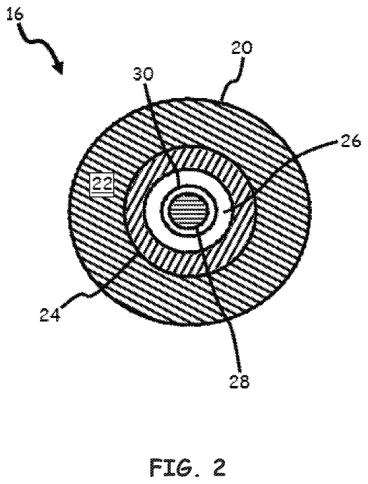

Control unit 12 controls a flow of fluid into and through supply lines 14 and hose 16. Supply lines 14 transports fluid to and from control unit 12 from fluid supply tanks (not shown in FIG. 1). Hose 16 delivers fluid from control unit 12 to spray gun 18. In this example and as will be discussed in further detail with respect to FIG. 2, hose 16 also regulates a temperature of the fluid flowing through hose 16 via a heating element. In some non-limiting embodiments, length L_{H} of hose 16 can be up to 410 feet. Spray gun 18 controls an output of fluid from hose 16 via a variable sized nozzle orifice that can be controlled via an actuator (e.g., a handle) operated by a user.

FIG. 2 is a cross-section view of hose 16 taken at 2-2 shown in FIG. 1 and shows protective cover 20, insulation 22, core 24, channel 26, and heating element 28 (with cover 30).

Protective cover 20 is a protective sheath. Insulation 22 is an insulating layer disposed within protective cover 20, surrounding other elements of hose 16. Core 24 is an elongated tube and can include a flexible material. Channel 26 is an opening extending through length L_{H} of hose 16. For example, channel 26 is formed by an internal cavity of hose 16, defined by core 24. During operation, channel 26 can be filled partially or completely with a fluid such as polyurethane foam or polyurea.

Heating element 28 is a wire that converts electric current into thermal energy and that converts thermal energy into electric current. For example, heating element 28 can be a coupling wire. In this example, heating element 28 is a metallic resistance heating element. In one non-limiting embodiment, a first material composition of heating element 28 can include 88% copper and 12% nickel. A temperature coefficient of resistance of this first material is 0.0004041 or 0.04041%. In this example, the temperature coefficient of resistance is a resistance-change factor per degree Celsius of temperature change. In another non-limiting embodiment, a second material composition of heating element 28 can include 70% nickel and 30% iron. A temperature coefficient of resistance of this second material composition is 0.00450 or 0.450%. In another non-limiting embodiment, the material composition of heating element 28 can include at least 50% copper, and more particularly can include more than 85% copper. Cover 30 is a sheath or covering.

Protective cover 20 is disposed around the exterior of hose 16. Insulation 22 is positioned radially in between and in contact with protective cover 20 and core 24. Core 24 is positioned radially in between and in contact with insulation 22 and channel 26. Channel 26 is disposed radially inward and extends through core 24. Channel 26 is also fluidly connected to control unit 12 and to spray gun 18 (as shown in FIG. 1).

In this example, heating element 28 is disposed inside of channel 26 and is in direct contact with the fluid occupying channel 26. In other non-limiting embodiments, heating element 28 can be located in or between any of protective cover 20, insulation 22, and/or core 24 (e.g., wrapped around core 24). Heating element 28 is electrically connected to and in data communication with control unit 12. Heating element 28 is connected to a fitting disposed on both ends of hose 16. As illustrated in FIG. 2, heating element 28 can be positioned at an axial centerpoint of hose 16. In another non-limiting embodiment, heating element 28 can occupy a position at a gravitational bottom of channel 26 (at the bottom of channel 26 as shown in FIG. 2), or a position therebetween. In yet another example, heating element 28 can be wrapped around a portion of an external surface of hose 16, a portion of protective cover 20, a portion of insulation 22, a portion of core 24, and/or a portion of channel 26. Cover 30 is disposed around an exterior of heating element 28. In one non-limiting embodiment, cover 30 can include a first high temperature insulation layer, a high tensile strength mesh, and/or a second layer of insulation.

Protective cover 20 protects hose 16 from damage caused by foreign objects coming into contact with hose 16. Protective cover 20 also prevents hose 16 from twisting or kinking. Insulation 22 acts as an insulating layer to minimize the transfer of thermal energy from the fluid in channel 26 to an ambient environment around hose 16. Core 24 contains the fluid within channel 26. Channel 26 provides an opening through which the fluid flows through hose 16. In this example, heating element 28 transfers thermal energy to the fluid in channel 26 and also measures a temperature of the fluid within hose 16.

For example, the temperature dependence of electrical resistance of heating element 28 can be used to sense or measure a temperature of the fluid in hose 16 by measuring a temperature of heating element 28. The temperature of heating element 28 is determined by measuring a resistance of heating element 28 at a specific temperature. The resistance of heating element 28 is measured by applying a known current through heating element 28, measuring a voltage drop across heating element 28, and calculating a resistance of heating element 28 according to Ohm's law (i.e., resistance=voltage/current).

After determining the resistance of heating element 28 at a particular operating temperature, the approximation for temperature dependence of electrical resistance of a conductor (i.e., Equation 1.1 below) can be used to solve for the operating temperature of heating element 28:

R_{T}=Rᵣ+RᵣαT−RᵣαTᵣ Equation 1.1

### Where,

T=current/operating temperature of the conductor
Tᵣ=reference temperature (in this non-limiting example, Tᵣ equals approximately 120° F. or 48.9° C.)
R_{T}=Resistance of the conductor at temperature T
Rᵣ=Resistance of the conductor at reference temperature Tᵣ
α=Temperature coefficient of resistance at reference temperature Tᵣ

Solving Equation 1.1 for the current/operating temperature of heating element 28 (e.g., the conductor), produces the following approximation—Equation 1.2:

$$T = β \frac{( \frac{{V}_{T} / {I}_{T}}{{R}_{r}} - 1 )}{α} + {T}_{r} \qquad Equation 1.2$$

### Where:

T=current/operating temperature of the fluid in hose 16
β=conversion factor that takes into account a cycle compensation and a flow rate compensation of system 10
V_{T}=Voltage drop across heating element 28 at temperature T
I_{T}=Current across heating element 28 at temperature T
Tᵣ=reference temperature
Rᵣ=Resistance of heating element 28 at reference temperature Tᵣ
α=Temperature coefficient of resistance at reference temperature Tᵣ

Because heating element 28 extends an entire of length L_{H} of hose 16, heating element 28 measures an average temperature of the fluid in hose 16 across all of length L_{H} of hose 16. Cover 30 protects heating element 28 and provides the function of a coupling element and is configured to effectuate direct coupling between heating element 28 and the fluid in channel 26. For example, as a coupling element effectuating direct coupling, cover 30 transfers electric current via physical contact between heating element 28 and the fluid in channel 26.

Existing fluid management systems often incorporate fluid temperature sensors that are susceptible to physical damage during use as well as provide a potential failure point with the fluid dispensing system. System 10 with heating element 28 being used to measure the fluid temperature within hose 16 allows for fluid temperature control of the fluid without the need for a second sensor (e.g., fluid temperature sensor) in the fluid stream. This will prevent physical damage to hose 16 and reduce the number of potential failure points within system 10.

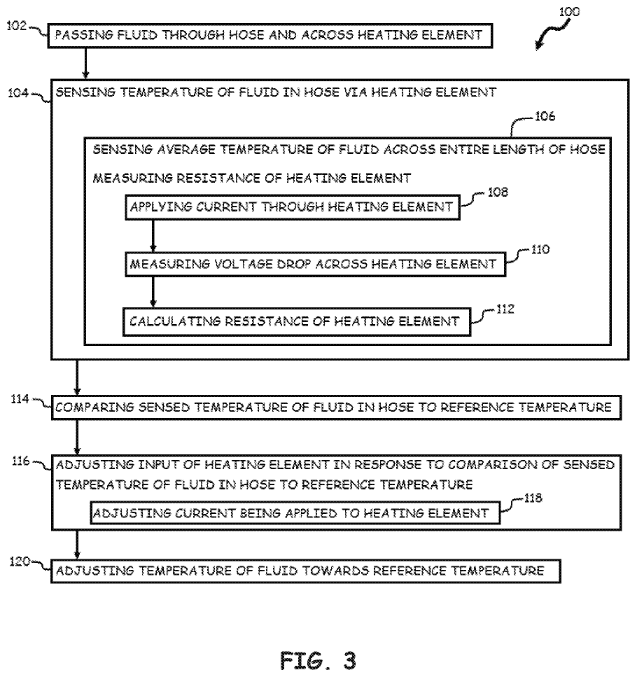

FIG. 3 shows a flowchart of method 100 that is a method of regulating a temperature of the fluid within hose 16 and includes steps 102-120.

Step 102 includes passing the fluid through hose 16 and across heating element 28. Step 104 includes sensing a temperature of the fluid in hose 16 via heating element 28 and step 106. Step 106 includes sensing an average temperature of the fluid across an entire length (i.e., length L_{H}) of hose 16 by measuring the resistance of heating element 28 and steps 108-112. Step 108 includes applying a current through heating element 28. Step 110 includes measuring, with control unit 12, a voltage drop across heating element 28. Step 112 includes calculating a resistance of heating element 28 by using Equation 1.1 provided above. In another example, the resistance of heating element 28 can be calculated using Equation 1.2 above. In one non-limiting embodiment, step 104 can also include using Equation 1.3 above to calculate the temperature of the fluid in hose 16.

Step 114 includes comparing the sensed temperature of the fluid in hose 16 to a reference temperature. In this example, the reference temperature can be 120° F. (or 48.9° C.), which can be representative of a critical temperature of the fluid. Step 116 includes adjusting an input of heating element 28 in response to the comparison of the sensed temperature of the fluid in hose 16 to the reference temperature and step 118. For example, step 116 can include adjusting (e.g., either increasing or decreasing) a voltage across heating element 28 in response to the comparison of the sensed temperature of the fluid in hose 16 to the reference temperature. For example, step 116 can include adjusting (e.g., either increasing or decreasing) a current sent through heating element 28 in response to the comparison of the sensed temperature of the fluid in hose 16 to the reference temperature. Step 118 includes adjusting the temperature of the fluid towards the reference temperature. In this example, the temperature of the fluid can be adjusted via transfer of thermal energy via conduction (e.g., physical contact) between heating element 28 and the fluid in channel 26.

In this example, method 100 can be used as a primary temperature sensing mode of system 10. In another non-limiting embodiment, method 100 can be used as a secondary mode, a tertiary mode, a back-up mode, or some other non-primary temperature sensing mode of operation of system 10.

While the disclosure has been described with reference to an exemplary embodiment(s), it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment(s) disclosed, but that the disclosure will include all embodiments falling within the scope of the appended claims.

1. A method of regulating a temperature of a fluid within a hose of a fluid dispensing system, the method comprising:
passing the fluid through the hose, wherein the fluid dispensing system comprises:
a control unit;
a hose attached to and fluidly connected with the control unit, the hose with a channel extending therethrough; and
a heating element mounted to the hose;
sensing, with the heating element, a temperature of the fluid in the hose;
comparing, with the control unit, the sensed temperature of the fluid in the hose to a reference temperature;
adjusting, with the control unit, an input of the heating element in response to the comparison of the sensed temperature of the fluid in the hose to the reference temperature such that the temperature of the fluid is adjusted towards the reference temperature.

2. The method of claim 1, wherein the heating element is a wire and is configured such that a resistance of the heating element changes in response to a change in a temperature of the heating element.

3. The method of claim 1, wherein sensing the temperature of the fluid in the hose with the heating element comprises measuring a resistance of the heating element.

4. The method of claim 3, wherein measuring the resistance of the heating element comprises:
applying a current through the heating element;
measuring a voltage drop across the heating element; and
calculating the resistance of the heating element from the measured voltage drop and applied current, according to Ohm's law.

5. The method of claim 1, wherein adjusting the input of the heating element comprises adjusting the current being applied to the heating element.

6. The method of claim 1, wherein sensing the temperature of the fluid in the hose with the heating element comprises sensing an average temperature of the fluid across an entire length of the hose.

7. The method of claim 1, wherein the heating element is disposed within the channel of the hose, wherein the heating element is in direct contact with the fluid, and wherein sensing the temperature of the fluid in the hose further comprises directly sensing the temperature of the fluid with the heating element.

8. The method of claim 1, wherein the heating element is wrapped around a core of the hose, wherein sensing the temperature of the fluid in the hose further comprises indirectly sensing the temperature of the fluid through the core of the hose with the heating element.

9. A heated hose assembly for managing a fluid, the heated hose assembly comprising:
a hose comprising:
a protective cover;
a core disposed radially inward from the protective cover; and
a channel formed by an internal cavity of the hose, the channel extending through the hose, wherein the channel is configured to transport the fluid through the hose;
a heating element mounted to the hose, wherein the heating element extends along a length of the hose, wherein the heating element is configured such that the resistance of the heating element changes in response to a change in a temperature of the heating element; and
a control unit detachably affixed to and in fluid communication with the hose, wherein the control unit is configured to supply a pressurized source of fluid into the channel of the hose, wherein the control unit is configured to supply current to the heating element, and wherein the control unit is configured to sense the resistance of the heating element.

10. The heated hose assembly of claim 9, wherein the control unit is configured to sense a change in the resistance of the heating element.

11. The heated hose assembly of claim 9, wherein the heating element is disposed within the channel of the hose.

12. The heated hose assembly of claim 9, wherein the heating element extends an entire length of the hose.

13. The heated hose assembly of claim 9, wherein the heating element is configured such that the temperature of the heating element changes in response to a change in current across the heating element.

14. The heated hose assembly of claim 9, wherein the heating element comprises a cover that is configured to transfer thermal energy from the heating element to the fluid in the channel of the hose.
